(19) United States
(12) Patent Application Publication
(10) Pub. No.: US 2026/0341097 A1
(43) Pub. Date: Oct. 29, 2026

(54) SYSTEM AND METHOD FOR MANAGING THE DELIVERY OF A FOOD PRODUCT

(71) Applicant: Little Caesar Enterprises, Inc., Detroit, MI (US)

(72) Inventors: James E. Mason, Breese, IL (US); David Koziol, Ann Arbor, MI (US); Kent A. Deemter, Hudsonville, MI (US); Kyle M. Bey, Davison, MI (US); Thomas Hennessy, Royal Oak, MI (US); Andrew Boncher, Brownstown, MI (US); Garrison James Hefter, Clawson, MI (US); Edward Joseph Gleich, III, Detroit, MI (US); David Scrivano, Detroit, MI (US); Eric Brasseur, Detroit, MI (US)

(21) Appl. No.: 19/657,229

(22) Filed: Apr. 24, 2026

Related U.S. Application Data
(60) Provisional application No. 63/796,148, filed on Apr. 28, 2025.

(51) Int. Cl. G07F 17/12; G06Q 10/0836; G07C 9/20; G07F 9/10

(52) U.S. Cl. CPC G07F 17/12; G06Q 10/0836; G07C 9/20; G07F 9/105

(57) ABSTRACT

A computer-implemented method, when executed on data processing hardware, causes the data processing hardware to perform operations. The operations include receiving an order associated with a first user and including a first product and a second product. The operations further include instructing a second user to deposit the first product in at least one receptacle of a plurality of receptacles of a heated storage device and to deposit the second product in at least one receptacle of a plurality of receptacles of a non-heated storage device. The operations further include receiving, at the heated storage device, an identifier associated with the order and the first user. The operations further include, responsive to receiving the identifier, activating a first indicator that indicates the at least one receptacle of the heated storage device and activating a second indicator that indicates the at least one receptacle of the non-heated storage device.

### CROSS-REFERENCE TO RELATED APPLICATION

This U.S. patent application claims priority under 35 U.S.C. § 119(e) to U.S. Provisional Application 63/796,148, filed on Apr. 28, 2025. The disclosure of this prior application is considered part of the disclosure of this application and is hereby incorporated by reference in its entirety.

### TECHNICAL FIELD

This disclosure relates to a system and method for managing the delivery of a food product, and more particularly to a system and method for securing an ordered food product and/or maintaining a temperature of an ordered food product prior to delivery.

### BACKGROUND

This section provides background information related to the present disclosure and is not necessarily prior art. Restaurants and other establishments that supply prepared (e.g., cooked-to-order) food products to customers often find it desirable to prepare the food product in advance of serving the food product to the customer. For example, restaurants offering carryout or take-out food service often prepare an ordered food product before the customer arrives at the restaurant to pick up the food product. In these situations, the restaurant may place the prepared food in a staging or waiting area where it can remain until it is picked up by the customer. While known systems and methods for handling and delivering prepared food products have proven acceptable for their intended use, a continuous need in the relevant art remains for improved systems and methods for ordering, handling, and delivering prepared food products.

### SUMMARY

This section provides a general summary of the disclosure and is not a comprehensive disclosure of its full scope or all of its features.

According to one aspect, the present disclosure provides a computer-implemented method. The computer-implemented method, when executed on data processing hardware, causes the data processing hardware to perform operations. The operations include receiving an order associated with a first user and including a first product and a second product. The operations further include instructing a second user to deposit the first product in at least one receptacle of a plurality of receptacles of a heated storage device and to deposit the second product in at least one receptacle of a plurality of receptacles of a non-heated storage device. The operations further include receiving, at the heated storage device, an identifier associated with the order and the first user. The operations further include, responsive to receiving the identifier, activating a first indicator that indicates the at least one receptacle of the heated storage device and activating a second indicator that indicates the at least one receptacle of the non-heated storage device.

Implementations of this aspect of the disclosure may include one or more of the following optional features. In some implementations, the heated storage device includes a user interface and the identifier is received at the user interface. In some further implementations, the user interface includes a display screen. In some even further implementations, the operations further include displaying a message at the display screen that indicates at least one of (i) the at least one receptacle of the heated storage device and (ii) the at least one receptacle of the non-heated storage device.

In some implementations, the heated storage device includes an employee interface having a display screen and instructing the second user includes displaying a message at the display screen. In some further implementations, the order is received at the employee interface.

In some implementations, instructing the second user to deposit the first product includes instructing the second user to deposit the first product in two or more receptacles of the plurality of receptacles of the heated storage device and the first indicator indicates the two or more receptacles of the heated storage device.

In some implementations, instructing the second user to deposit the second product includes instructing the second user to deposit the second product in two or more receptacles of the plurality of receptacles of the non-heated storage device and the second indicator indicates the two or more receptacles of the non-heated storage device.

In some implementations, the first indicator includes a plurality of lights that at least partially circumscribe at least one first opening corresponding to the at least one receptacle of the heated storage device. The second indicator includes a plurality of lights that at least partially circumscribe at least one first shelving opening corresponding to the at least one receptacle of the non-heated storage device. In some further implementations, the at least one receptacle of the heated storage device and the at least one receptacle of the non-heated storage device are adjacent to one another. A portion of the plurality of lights of the first indicator and a portion of the plurality of lights of the second indicator are activated so that the activated portions collectively circumscribe the at least one first opening corresponding to the at least one receptacle of the heated storage device and the at least one first opening corresponding to the at least one receptacle of the non-heated storage device.

In some implementations, the heated storage device includes a heated storage locker.

In some implementations, the non-heated storage device includes a non-heated shelving unit.

In some implementations, the identifier includes one of (i) a QR code or other scannable medium received at a scanner of the heated storage device and (ii) a numerical pin or other input received at the heated storage device.

According to another aspect, the present disclosure provides a food management system. The food management system includes a heated storage locker. The heated storage locker includes a first side including a plurality of first locker openings, a second side opposite the first side, the second side including a plurality of second locker openings, and a plurality of locker receptacles. Each locker receptacle of the plurality of locker receptacles extends between a respective first locker opening of the plurality of first locker openings and a respective second locker opening of the plurality of second locker openings. The food management system also includes a non-heated shelving unit. The non-heated shelving unit includes a first side including a plurality of first shelving openings, a second side opposite the first side, the second side including a plurality of second shelving openings, and a plurality of shelving receptacles. Each shelving receptacle of the plurality of shelving receptacles extends between a respective first shelving opening of the plurality of first shelving openings and a respective second shelving opening of the plurality of second shelving openings. The food management system also includes an employee interface disposed at the second side of the heated storage locker. The employee interface is configured to, responsive to receiving an order associated with a first user and including a first food product and a second food product, instruct a second user to deposit the first food product in at least one locker receptacle of the plurality of locker receptacles and to deposit the second food product in at least one shelving receptacle of the plurality of shelving receptacles. The food management system also includes a user interface disposed at the first side of the heated storage locker. The user interface is configured to receive an identifier associated with the order associated with the first user and activate a first indicator that indicates the at least one locker receptacle of the heated storage locker and a second indicator that indicates the at least one shelving receptacle of the non-heated shelving unit.

Implementations of this aspect of the disclosure may include one or more of the following optional features. In some implementations, the employee interface includes a display screen configured to display a message to instruct the second user. In some further implementations, the message at the display screen of the employee interface indicates (i) the at least one locker receptacle of the plurality of locker receptacles of the heated storage locker and (ii) the at least one shelving receptacle of the plurality of shelving receptacles of non-heated shelving unit.

In some implementations, the user interface includes a display screen configured to display a message that indicates at least one of (i) the at least one locker receptacle of the plurality of locker receptacles of the heated storage locker and (ii) the at least one shelving receptacle of the plurality of shelving receptacles of non-heated shelving unit.

In some implementations, the first indicator includes a plurality of lights that at least partially circumscribe the at least one first locker opening of the plurality of first locker openings corresponding to the at least one locker receptacle of the heated storage locker. The second indicator includes a plurality of lights that at least partially circumscribe the at least one first shelving opening of the plurality of first shelving openings corresponding to the at least one shelving receptacle of the non-heated shelving unit. In some further implementations, the at least one locker receptacle of the heated storage locker and the at least one shelving receptacle of the non-heated shelving unit are adjacent one another and a portion of the plurality of lights of the first indicator and a portion of the plurality of lights of the second indicator are activated so that the activated portions of the plurality of lights collectively circumscribe the at least one first locker opening corresponding to the at least one locker receptacle of the heated storage locker and the at least one first shelving opening corresponding to the at least one shelving receptacle of the non-heated shelving unit.

In some implementations, the identifier includes one of (i) a QR code or other scannable medium received at a scanner of the user interface of the heated storage locker and (ii) a numerical pin or other input received at the user interface of the heated storage locker.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a front-view of an example food management system in accordance with the principles of the present disclosure.

FIG. 2A is a perspective view of an example heated storage device in accordance with the principles of the present disclosure.

FIG. 2B is a front view of the heated storage device of FIG. 2A

FIG. 2C is a rear-view of the heated storage device of FIG. 2A.

FIG. 2D is a side view of the heated storage device of FIG. 2A.

FIG. 3A is a front perspective view of an example non-heated storage device in accordance with the principles of the present disclosure.

FIG. 3B is a rear perspective view of the non-heated storage device of FIG. 3A.

FIG. 4 is a sectional view of the heated storage device of FIG. 2A, showing an example indicator of the food management system in accordance with the principles of the present disclosure.

FIG. 5 is a flowchart of an example method of operating a food management system in accordance with the principles of the present disclosure.

FIGS. 6A-6F are partial views of the food management system of FIG. 1, showing example activations of the indicators in accordance with the principles of the present disclosure.

FIG. 7 is a schematic diagram of an example control system of the food management system in accordance with the principles of the present disclosure.

FIG. 8 is a schematic diagram of an example power circuit of the food management system in accordance with the principles of the present disclosure.

Like reference symbols in the various drawings indicate like elements.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

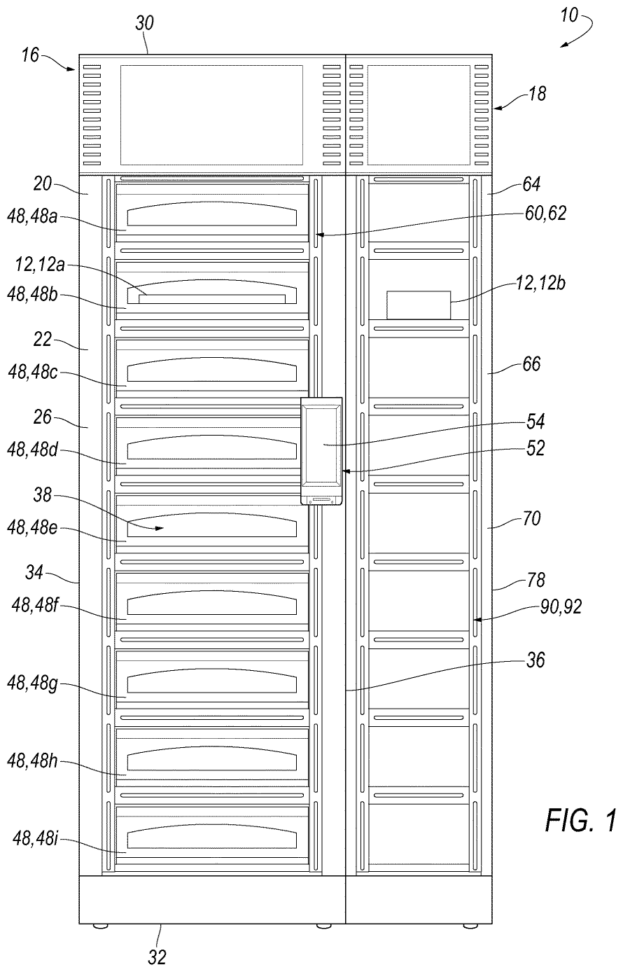

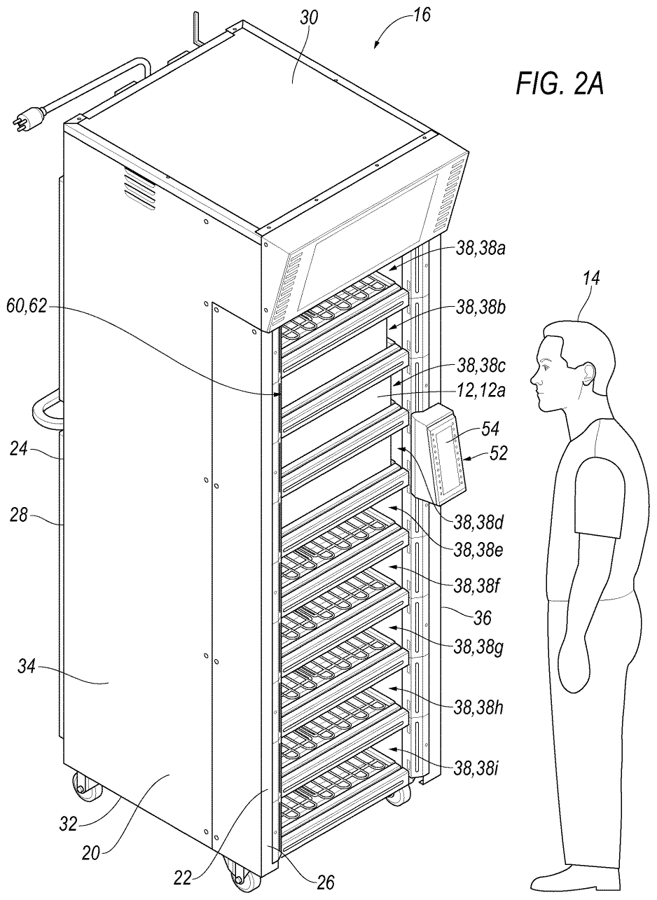

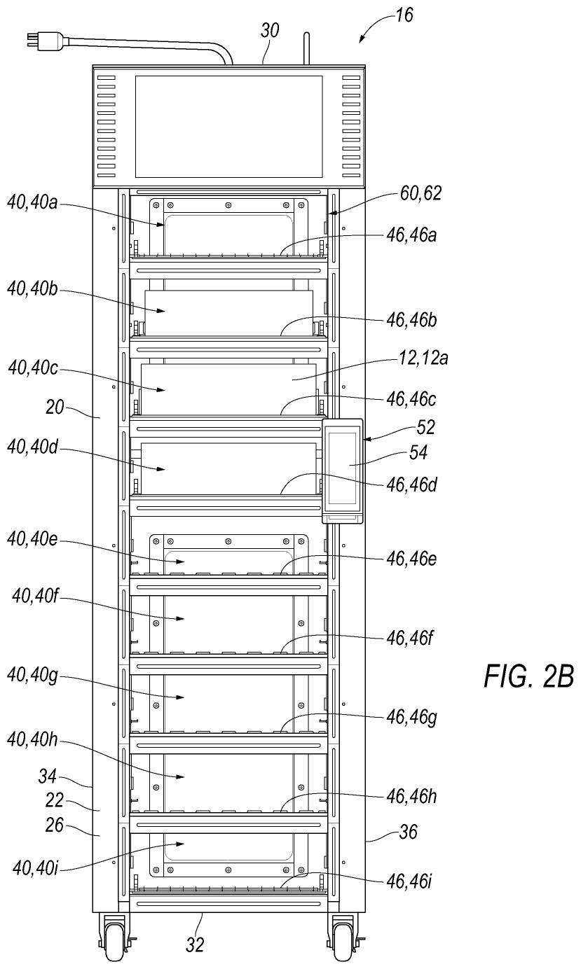

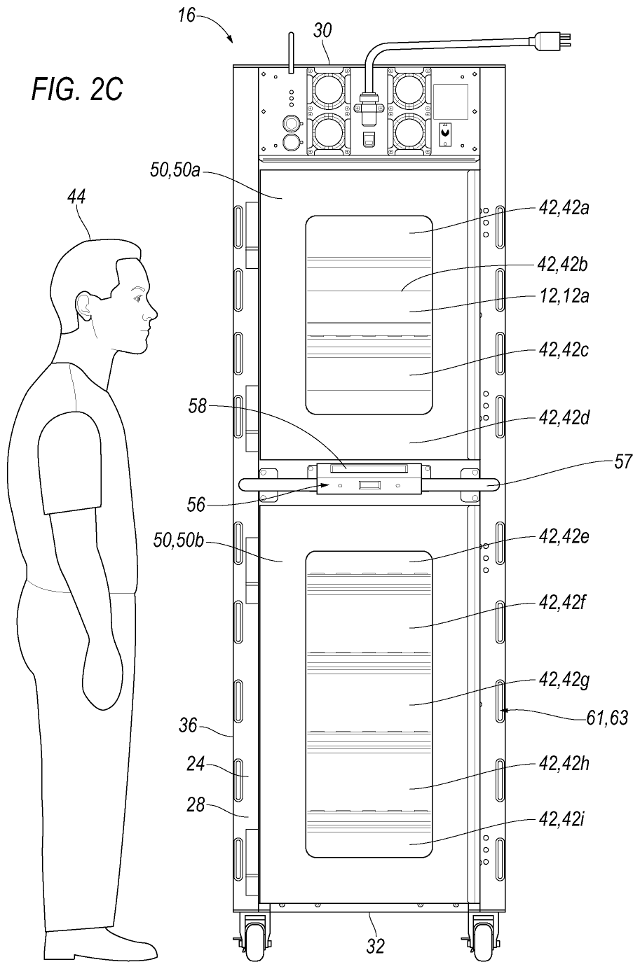

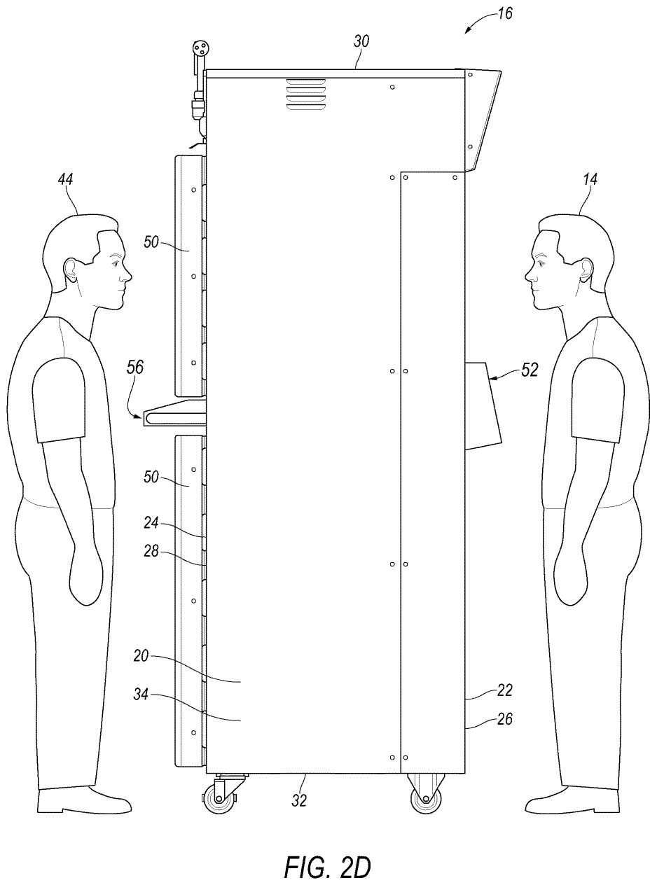

Referring to FIGS. 1 and 2A, a food management system 10 is illustrated in accordance with the principles of the present disclosure. The food management system 10 may be disposed in, and utilized by, a restaurant or other similar establishment to manage the ordering of food products 12 by, and the delivery of food products 12 to, a first user 14 such as, for example, a consumer or a third-party delivery service. For example, in some implementations, the food management system 10 may be utilized by a pizza-making restaurant. In this regard, while the food products 12 may be generally shown and described herein as including food products like pizzas, breadsticks, chicken, sauces, dessert items and beverages, for example, it will be appreciated that the food products 12 may include other items within the scope of the present disclosure. Further, the food products 12 may include at least a first food product 12a and a second food product 12b. The first food product 12a may be associated with items intended to remain hot or warm in a heated environment, such as pizzas, breadsticks, chicken, and the like. Meanwhile, the second food product 12b may be associated with items intended to remain at ambient temperature, or cold in a non-heated environment, such as sauces, dessert items, beverages, and the like. In some examples, the second products that do not need to be heated, may include non-food products such as shirts, hats or other merchandise, plates and other eating utensils, and the like.

The food management system 10 includes a heated storage device or storage locker 16 configured to hold first food products 12a in a heated environment for later pickup by the first user 14, and the food management system 10 includes a non-heated storage device or shelving unit 18 configured to hold second food products 12b in a cooled or ambient environment for later pickup by the first user 14. As discussed further below, the food management system 10 is configured to manage orders associated with the food products 12 to instruct the restaurant to make the food products 12, direct placement of the food products 12 into the heated storage locker 16 and/or the non-heated shelving unit 18, and to control and indicate pickup of the food products 12 from the heated storage locker 16 and/or the non-heated shelving unit 18 by the first user 14. It should be appreciated that the cooled or ambient environment of the non-heated shelving unit 18 may be actively refrigerated or cooled to below freezing temperatures, passively cooled, or maintained at room temperature, depending on the requirements of the second food products 12b.

The heated storage locker 16 and the non-heated shelving unit 18 represent separate units disposed in the restaurant and may be disposed remote from one another or adjacent to one another, such as in the illustrated example. Further, the heated storage locker 16 includes one or more cabinets 20 arranged in respective columns and/or stacks. In this regard, while the heated storage locker 16 is shown and described herein as including one set or stack of cabinets 20, it should be appreciated that the heated storage locker 16 may include more than one set or stack of cabinets 20 without deviating from the context of the present disclosure.

With reference to FIGS. 2A-2D, the storage locker 16 includes a first side or front surface 22 and a second side or rear surface 24 opposite the first side 22. A front panel or wall 26 may be disposed at the first side 22 of the storage locker 16, and a rear panel or wall 28 may be disposed at the second side 24 of the storage locker 16. Further, the storage locker 16 may include an upper panel or wall 30 that extends between the first side 22 and the second side 24 at an upper portion of the storage locker 16, a lower panel or wall 32 that extends between the first side 22 and the second side 24 at a lower portion of the storage locker 16 opposite the upper portion, a first side panel or wall 34 that extends between the first side 22 and the second side 24 at a first side portion of the storage locker 16, and a second side panel or wall 36 that extends between the first side 22 and the second side 24 at a second side portion of the storage locker 16 opposite the first side portion. A plurality of chambers or locker receptacles 38 extend between the first side 22 and the second side 24 of the storage locker 16 to define the cabinets 20 and are respectively configured to hold first food products 12a. The front wall 26, rear wall 28, upper wall 30, lower wall 32, first side wall 34, and second side wall 36 may collectively surround and/or define the plurality of locker receptacles 38. While the storage locker 16 is shown and described herein as defining a substantially rectangular prism, it should be appreciated that the storage locker 16 may define other shapes surrounding the plurality of locker receptacles 38 without deviating from the context of this disclosure.

In the illustrated example, the storage locker 16 includes nine individual locker receptacles 38a-38i that are vertically disposed or stacked relative to one another between the lower wall 32 of the storage locker 16 and the upper wall 30 of the storage locker 16. A first locker receptacle 38, 38a is positioned closest to the upper wall 30 and a ninth locker receptacle 38, 38i is positioned closest to the lower wall 32. It should be appreciated that the heated storage locker 16 may include any suitable number of locker receptacles 38 without deviating from the context of this disclosure.

The first side 22 of the storage locker 16 includes a plurality of first locker openings 40 extending through the front wall 26 and in communication with the individual locker receptacles 38. In this regard, the plurality of first locker openings 40 may provide the first user 14 access to the plurality of locker receptacles 38. Further, each first locker opening 40 corresponds to a respective locker receptacle 38. The second side 24 of the storage locker 16 includes a plurality of second locker openings 42 extending through the rear wall 28 and in communication with the individual locker receptacles 38. In this regard, the plurality of second locker openings 42 may provide a second user 44 access to the plurality of locker receptacles 38. The second user 44 may be an employee or other person affiliated with the restaurant or establishment at which the food management system 10 is located. For example, the second side 24 of the storage locker 16 may face a kitchen or prep area of the venue so that the second user 44 may be granted access to the locker receptacles 38 via the second locker openings 42 while in the kitchen or prep area, while the first side 22 of the storage locker 16 faces a lobby or reception area of the venue so that the first user 14 may be granted access to the locker receptacles 38 via the first locker openings 40 while in the lobby or reception area. Further, each second locker opening 42 corresponds with a respective locker receptacle 38, such that each locker receptacle 38 extends between a corresponding first locker opening 40 and a corresponding second opening 42.

In the illustrated example, the storage locker 16 includes nine first locker openings 40a-40i, with each first locker opening 40 corresponding to a respective individual locker receptacle 38. An uppermost first locker opening 40, 40a is positioned closest to the upper wall 30 and a lowermost first locker opening 40, 40i is positioned closest to the lower wall 32. Similarly, the storage locker 16 includes nine second locker openings 42a-42i, with each second locker opening 42 corresponding to a respective individual locker receptacle 38. An uppermost second locker opening 42, 42a is positioned closest to the upper wall 30 and a lowermost second locker opening 42, 42i is positioned closest to the lower wall 32. It should be appreciated that the heated storage locker 16 may include any suitable number of first locker openings 40 and corresponding second locker openings 42 without deviating from the context of this disclosure.

Each locker receptacle 38 includes a respective receiving structure or rack or shelf 46 such that the storage locker 16 includes a plurality of racks 46. Each rack 46 may be configured to accept and hold one or more food products 12 disposed in the locker receptacle 38, and specifically, one or more first food products 12a. In this regard, the racks 46 may extend between the first side 22 and the second side 24 of the storage locker 16 and be spaced from one another between the lower wall 32 and the upper wall 30. Further, each rack 46 may be fixedly or removably attached to one or more of the front wall 26, rear wall 28, upper wall 30, lower wall 32, first side wall 34, and second side wall 36 such that each rack 46 remains rigidly disposed at a lower portion of each locker receptacle 38.

In the illustrated example, the storage locker 16 includes nine racks 46a-46i, with each rack 46 corresponding to a respective locker receptacle 38. A first rack 46, 46a is positioned closest to the upper wall 30 and a ninth rack 46, 46i is positioned closest to the lower wall 32. It should be appreciated that the heated storage locker 16 may include any suitable number of racks 46 without deviating from the context of this disclosure.

With continued reference to FIGS. 1-2D, the storage locker 16 may also include a plurality of first doors 48 that are movably coupled to the storage locker 16 at or near the first side 22, with each first door 48 corresponding to a respective locker receptacle 38 such that each first door 48 (i) prevents access to one of the plurality of locker receptacles 38 through the corresponding first locker opening 40 in a closed position and (ii) allows access to the one of the plurality of locker receptacles 38 through the corresponding first locker opening 40 in an open position. In this regard, each first locker opening 40 may further include a sensor to detect whether the corresponding first door 48 is in the open position or the closed position. This configuration allows the first user 14 to access a desired locker receptacle 38 of the plurality of locker receptacles 38 by opening the first door 48 that corresponds to the first locker opening 40 at the desired locker receptacle 38.

The storage locker 16 may include nine first doors 48a-48i, with each first door 48 corresponding to a respective locker receptacle 38. An uppermost first door 48, 48a may be positioned closest to the upper wall 30 and a lowermost first door 48, 48i may be positioned closest to the lower wall 32. It should be appreciated that the heated storage locker 16 may include any suitable number of first doors 48 without deviating from the context of this disclosure, such as if one first door 48 covered two or more adjacent first locker openings 40 of corresponding adjacent locker receptacles 38.

The storage locker 16 may also include one or more second doors 50 that are movably coupled to the storage locker 16 at or near the second side 24 such that the second door 50, with each second door 50 corresponding to one or more corresponding locker receptacles 38, such that each second door 50 (i) prevents access to one or more of the plurality of locker receptacles 38 through the corresponding one or more second locker openings 42 in a closed position and (ii) allows access to the one or more locker receptacles 38 through the corresponding one or more second locker openings 42 in an open position. In the illustrated example, the storage locker 16 includes a first or upper second door 50, 50a that corresponds to at least the first locker receptacle 38a, a second locker receptacle 38b, a third locker receptacle 38c, and a fourth locker receptacle 38d. A second or lower second door 50, 50b corresponds at least to a fifth locker receptacle 38e, a sixth locker receptacle 38f, a seventh locker receptacle 38g, an eighth locker receptacle 38h, and the ninth locker receptacle 38i. Thus, the second user 44 may be granted access to more than one locker receptacle 38 at a time when opening one of the second doors 50. Further, the second doors 50 may be configured with hinges that are robust to withstand frequent opening and closing. The hinges may also be configured to maintain the second doors 50 in the open position or maintain the second doors 50 in the closed position. The second doors 50 may also be configured to lift off the hinges so as to be conveniently removable when desired, such as for cleaning or maintenance. A plurality of hinges may be present at the rear wall 28 at a position adjacent to the first side wall 34 and the rear wall 28 at a position adjacent to the second side wall 36. This enables the second doors 50 to be installed wherein the second doors 50 hinge adjacent to the first side wall 34 or hinge adjacent to the second side wall 36.

A user interface 52 is disposed at the first side 22 of the storage locker 16 and does not block or interrupt or space the stack of locker receptacles 38. In other words, the user interface 52 is disposed at the first side 22 of the storage locker 16 and alongside or adjacent the locker receptacles 38. This allows the locker receptacles 38 to occupy space at the most convenient and accessible height range of the storage locker 16, while simultaneously providing access to the user interface 52 at the convenient and accessible heights. For example, the user interface 52 may be positioned adjacent to one or more of the first doors 48 at the front wall 26 of the storage locker 16. Further, the user interface 52 may be positioned between the fourth locker receptacle 38d and the fifth locker receptacle 38e so as to ergonomically dispose the user interface 52 at an accessible height for the first user 14 (FIG. 2D). The user interface 52 includes a display screen 54 and may further include a touchscreen, a keypad, a scanner, and the like. In this regard, the first user 14 may interact with the user interface 52 in a variety of ways, such as to view messages displayed at the display screen 54 and to provide inputs at the touchscreen, the keypad, the scanner, and the like. The scanner may be positioned at an underside of the user interface 52.

An employee interface 56 is disposed at the second side 24 of the storage locker 16 between respective locker receptacles 38, such as between the fourth locker receptacle 38d and the fifth locker receptacle 38e, such that the employee interface 56 is at a highly visible and accessible height for the second user 44 interacting with the employee interface 56 (FIG. 2D). For example, the employee interface 56 may be disposed between the upper second door 50a and the lower second door 50b at the rear wall 28 of the storage locker 16. In some examples, a grab bar or handle 57 may be disposed between the upper second door 50a and the lower second door 50b so that the second user 44 may easily maneuver the storage locker 16 within the restaurant. The handle 57 is robust enough and positioned at an accessible position for routine activities. The employee interface 56 may be disposed at and/or integrated with the handle 57. The employee interface 56 includes a display screen 58 that may further include a touchscreen, a keypad, a scanner, and the like. In this regard, the second user 44 may interact with the employee interface 56 in a variety of ways, such as to view messages displayed at the display screen 58 and to provide inputs at the touchscreen, the keypad, the scanner, and the like.

Thus, with the storage locker 16 disposed in the restaurant, the first user 14 may place an order for one or more food products 12, such as according to methods described further below. In response to the order, the employee interface 56 may display a message at the display screen 58 corresponding to the order of the first user 14. For example, the message at the display screen 58 may indicate the food products 12 included in the first order and where to place the food products 12 within the storage locker 16 (e.g., the message may indicate which locker receptacles 38 of the storage locker 16 should receive the first food products 12a). Alternatively, if the plurality of locker receptacles 38 are occupied, the display screen 58 may indicate to the second user 44 that the food products 12 are not eligible to be placed in the locker receptacles 38. Responsive to the message at the display screen 58, the second user 44 may place the food products 12 in one or more respective locker receptacles 38 of the storage locker 16. When the first user 14 arrives at the restaurant, the first user 14 may provide an input, such as an identifier, to the user interface 52. The identifier may be a QR code or other scannable medium provided by the first user 14 (e.g., a barcode), such as via a display of a mobile device associated with the first user 14. Alternatively or conjunctively, the identifier may be a multi-digit numerical and/or alphabetical code. As described further below, providing the identifier to the user interface 52 causes one or more corresponding first doors 48 to open and provide access to the locker receptacles 38 holding the food products 12 associated with the order of the first user 14.

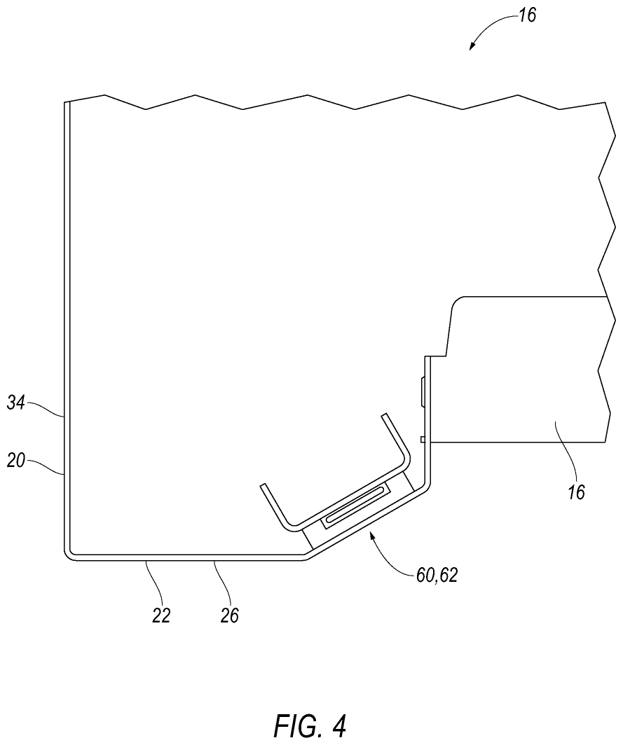

As shown in FIGS. 1 and 4, a plurality of first indicators 60 are disposed at the first side 22 of the heated storage locker 16 and are configured to visually indicate the locker receptacles 38 or racks 46 of the heated storage locker 16 that contain the food products 12 associated with the order of the first user 14. In other words, the first indicator 60 directs the first user 14 to the one or more locker receptacles 38 that are holding the food products 12 included in the order. The first indicator 60 may include a plurality of lights 62. A portion of the plurality of lights 62 may circumscribe one or more of the first locker openings 40 corresponding to the one or more locker receptacles 38 holding the food products 12 associated with the order of the first user 14.

For example, a portion of the plurality of lights 62 may circumscribe two of the first locker openings 40 that are positioned closest to the upper wall 30 of the storage locker 16 when the food products 12 associated with the order of the first user 14 are located in the two locker receptacles 38 positioned closest to the upper wall 30. In another example, a portion of the plurality of lights 62 may circumscribe two of the first locker openings 40 that are positioned closest to the lower wall 32 of the storage locker 16 when the food products 12 associated with the order of the first user 14 are located in the two locker receptacles 38 positioned closest to the lower wall 32. When the first indicator 60 is activated, the plurality of lights 62 may flash, remain steadily illuminated, or illuminate in any suitable manner.

In a similar manner, a plurality of first employee indicators 61 may be disposed at the second side 24 of the heated storage locker 16 and are configured to visually indicate the locker receptacles 38 or racks 46 of the heated storage locker 16 configured to receive the food products 12 associated with the order of the first user 14. In other words, the first employee indicator 61 directs the second user 44 to the one or more locker receptacles 38 at which the food products 12 included in the order are to be placed for later retrieval by the first user 14. The first employee indicator 61 may include a second plurality of lights 63. In the illustrated example, a portion of the second plurality of lights 63 are disposed at or adjacent to one side of each locker receptacle 38 at the second side 24 and another portion of the second plurality of lights 63 are disposed at or adjacent to an opposing side of each locker receptacle 38 at the second side 24. Respective portions or pairs of the second plurality of lights 63 may be illuminated at opposing sides of a respective locker receptacle 38 to instruct the second user 44 to place food products 12 in the respective receptacle 38.

The plurality of lights 62 include vertically extending light bars disposed alongside respective locker receptacles 38 and horizontally extending light bars disposed between respective locker receptacles 38 such that, when illuminated in groups, the plurality of lights 62 may substantially circumscribe or encircle respective first locker openings 40 or groups of first locker openings 40 corresponding to the respective locker receptacles 38. In a similar manner, the second plurality of lights 63 include vertically extending light bars disposed alongside respective locker receptacles 38. The light bars included in the plurality of lights 62 and the second plurality of lights 63 are shown as elongated or pill-shaped light bars. However, the light bars may include any suitable shape and configuration within the context of this disclosure. For example, the light bars may include a series of individualized light sources that are disposed adjacent one another in a linear or non-linear configuration. In another example, the light bars may be rectangularly shaped. In yet another example, the light bars may be curved or bent or angled.

As stated above, the heated storage locker 16 and the non-heated shelving unit 18 may be adjacent to one another. For example, the non-heated shelving unit 18 may be adjacent to the second side wall 36 of the storage locker 16.

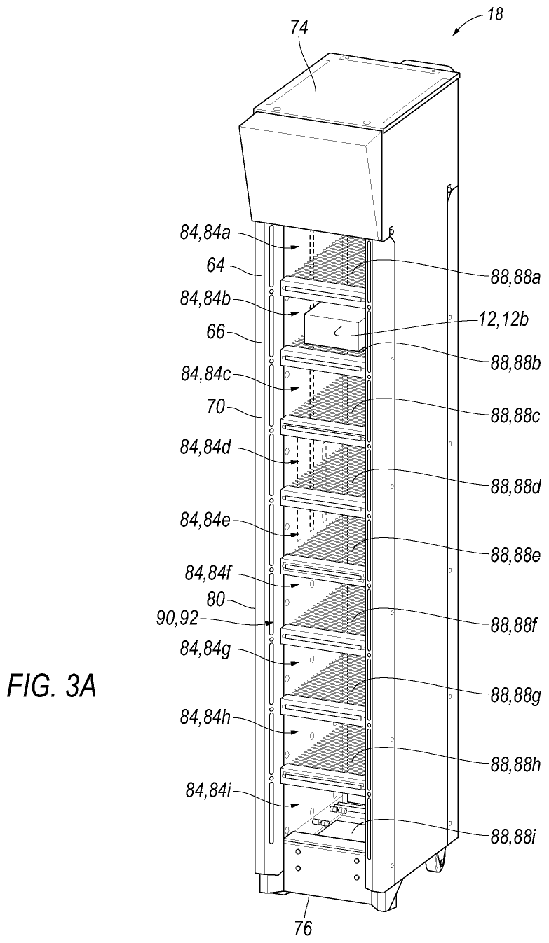

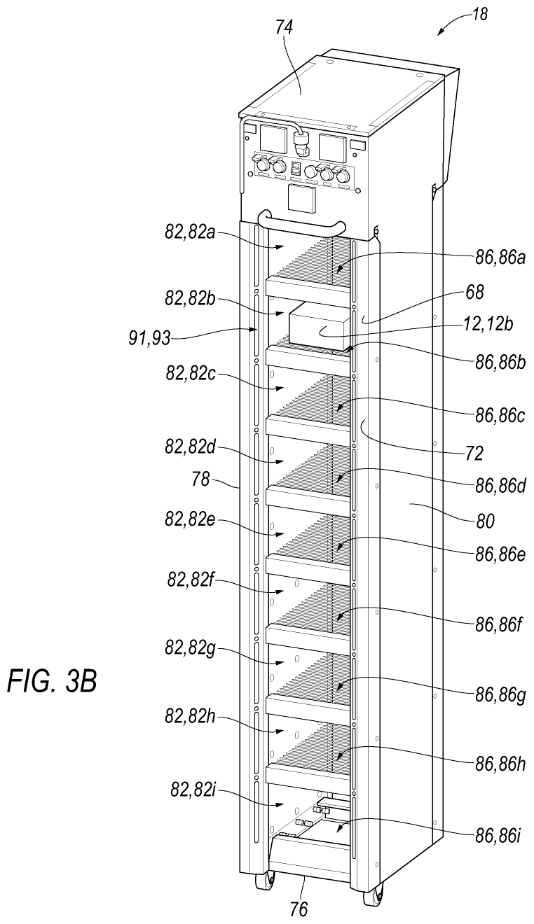

With reference to FIGS. 3A-3B, the non-heated storage device or non-heated shelving unit 18 includes one or more shelves or cubbies 64 arranged in respective columns and/or stacks. In this regard, while the non-heated shelving unit 18 is shown and described herein as including one set or stack of shelves 64, it should be appreciated that the non-heated shelving unit 18 may include more than one stack of shelves 64 without deviating from the context of the present disclosure.

The shelving unit 18 includes a first side or front surface 66 and a second side or rear surface 68 opposite the first side 66. A front panel or wall 70 may be disposed at the first side 66 of the shelving unit 18, and a rear panel or wall 72 may be disposed at the second side 68 of the shelving unit 18. Further, the shelving unit 18 may include an upper panel or wall 74 that extends between the first side 66 and the second side 68 at an upper portion of the shelving unit 18, a lower panel or wall 76 that extends between the first side 66 and the second side 68 at a lower portion of the shelving unit 18 opposite the upper portion, a first side panel or wall 78 that extends between the first side 66 and the second side 68 at a first side portion of the shelving unit 18, and a second side panel or wall 80 that extends between the first side 66 and the second side 68 at a second side portion of the shelving unit 18 opposite the first side portion. A plurality of shelving receptacles 82 extend between the first side 66 and the second side 68 of the shelving unit 18 and are respectively configured to hold second food products 12b. The front wall 70, rear wall 72, upper wall 74, lower wall 76, first side wall 78, and second side wall 80 may collectively surround and/or define the plurality of shelving receptacles 82. While the shelving unit 18 is shown and described herein as defining a substantially rectangular prism, it should be appreciated that the shelving unit 18 may define other shapes surrounding the plurality of shelving receptacles 82 without deviating from the context of this disclosure.

In the illustrated example, the shelving unit 18 includes nine individual shelving receptacles 82a-82i that are vertically disposed or stacked relative to one another between the lower wall 76 of the shelving unit 18 and the upper wall 74 of the shelving unit 18. A first shelving receptacle 82, 82a is positioned closest to the upper wall 74 and a ninth shelving receptacle 82, 82i is positioned closest to the lower wall 76. It should be appreciated that the non-heated shelving unit 18 may include any suitable number of shelving receptacles 82 without deviating from the context of this disclosure.

The first side 66 of the shelving unit 18 includes a plurality of first shelving openings 84 extending through the front wall 70 and in communication with the individual shelving receptacles 82. In this regard, the plurality of first shelving openings 84 may provide the first user 14 access to the plurality of shelving receptacles 82. Further, each first shelving opening 84 corresponds to a respective shelving receptacle 82. In a similar manner, the second side 68 of the shelving unit 18 includes a plurality of second shelving openings 86 extending through the rear wall 72 and in communication with the individual shelving receptacles 82. In this regard, the plurality of second shelving openings 86 may provide the second user 44 access to the plurality of shelving receptacles 82. The second user 44 may be an employee or other person affiliated with the restaurant or establishment at which the food management system 10 is located. Further, each second shelving opening 86 corresponds with a respective shelving receptacle 82, such that each shelving receptacle 82 extends between a corresponding first shelving opening 84 and a corresponding second shelving opening 86.

In the illustrated example, the shelving unit 18 includes nine first shelving openings 84a-84i, with each first shelving opening 84 corresponding to a respective individual shelving receptacle 82. An uppermost first shelving opening 84, 84a is positioned closest to the upper wall 74 and a lowermost first shelving opening 84, 84i is positioned closest to the lower wall 76. Similarly, the shelving unit 18 includes nine second shelving openings 86a-86i, with each second shelving opening 86 corresponding to a respective individual shelving receptacle 82. An uppermost second shelving opening 86, 86a is positioned closest to the upper wall 74 and a lowermost second shelving opening 86, 86i is positioned closest to the lower wall 76. It should be appreciated that the non-heated shelving unit 18 may include any suitable number of first shelving openings 84 and corresponding second shelving openings 86 without deviating from the context of this disclosure.

Each shelving receptacle 82 includes a respective receiving structure or rack or shelf 88 such that the shelving unit 18 includes a plurality of racks 88. Each rack 88 may be configured to accept and hold one or more food products 12 disposed in the shelving receptacle 82, and specifically, one or more second food products 12b. In this regard, the racks 88 may extend between the first side 66 and the second side 68 of the shelving unit 18 and be spaced from one another between the lower wall 76 and the upper wall 74. Further, each rack 88 may be fixedly or removably attached to one or more of the front wall 70, rear wall 72, upper wall 74, lower wall 76, first side wall 78, and second side wall 80 such that each rack 88 remains rigidly disposed at a lower portion of each shelving receptacle 82.

In the illustrated example, the shelving unit 18 includes nine racks 88a-88i, with each rack 88 corresponding to a respective shelving receptacle 82. A first rack 88, 88a is positioned closest to the upper wall 74 and a ninth rack 88, 88i is positioned closest to the lower wall 76. It should be appreciated that the non-heated shelving unit 18 may include any suitable number of racks 88 without deviating from the context of this disclosure.

With continued reference to FIGS. 3A-3D, the shelving unit 18 may also include a covering or screen that is movably coupled to the shelving unit 18 at or near the first side 66 such that the covering (i) prevents access to the plurality of shelving receptacles 82 through the plurality of first shelving openings 84 in a closed position and (ii) allows access to the plurality of shelving receptacles 82 through the plurality of first shelving openings 84 in an open position. The covering may extend between the upper wall 74 and the lower wall 76 to as to prevent access to the plurality of first shelving openings 84 when the covering is in the closed position. Alternatively, the covering may include a plurality of coverings that are movably coupled to the shelving unit 18 at or near the first side 66 wherein each covering of the plurality of coverings (i) prevents access to the plurality of shelving receptacles 82 through the plurality of first shelving openings 84 in the closed position and (ii) allows access to the plurality of shelving receptacles 82 through the plurality of first shelving openings 84 in the open position. In this regard, each covering of the plurality of coverings corresponds to a first shelving opening 84 of the plurality of first shelving openings 84. This configuration allows the first user 14 to access a desired shelving receptacle 82 of the plurality of shelving receptacles 82 by opening the covering that corresponds to the first shelving opening 84 at the desired shelving receptacle 82. Optionally, the covering may include a strip curtain that covers the respective first shelving openings 84 and that is movable or separable by the first user 14 when retrieving items from the shelving unit 18.

Thus, with the shelving unit 18 disposed in the restaurant, the first user 14 may place an order for one or more food products 12, such as according to methods described further below. In response to the order, the employee interface 56 at the storage locker 16 may display a message at the display screen 58 corresponding to the order of the first user 14. For example, the message at the display screen 58 may indicate the food products 12 included in the first order and where to place the food products 12 within the shelving unit 18. Responsive to the message at the display screen 58 at the storage locker 16, the second user 44 may place the food products 12 in one or more respective shelving receptacles 82 of the shelving unit 18. When the first user 14 arrives at the restaurant, the first user 14 may provide an input, such as an identifier, to the user interface 52 at the storage locker 16. As described further below, providing the identifier to the user interface 52 at the storage locker 16 causes second indicators 90 to identify the shelving receptacles 82 holding second food products 12b associated with the order.

As shown in FIGS. 1 and 3A-3B, a plurality of second indicators 90 are disposed at first side 66 of the non-heated shelving unit 18 and are configured to visually indicate the shelving receptacles 82 or racks 88 of the non-heated shelving unit 18 that contain the food products 12 associated with the order of the first user 14. In other words, the second indicator 90 directs the first user 14 to the one or more shelving receptacles 82 that are holding the food products 12 included in the order. The second indicator 90 may include a plurality of lights 92. A portion of the plurality of lights 92 may circumscribe one or more of the first shelving openings 84 corresponding to the one or more shelving receptacles 82 holding the food products 12 associated with the order of the first user 14.

For example, a portion of the plurality of lights 92 may circumscribe two of the first shelving openings 84 that are positioned closest to the upper wall 74 of the shelving unit 18 when the food products 12 associated with the order of the first user 14 are located in the two shelving receptacles 82 positioned closest to the upper wall 74. In another example, a portion of the plurality of lights 92 may circumscribe two of the first shelving openings 84 that are positioned closest to the lower wall 76 of the shelving unit 18 when the food products 12 associated with the order of the first user 14 are located in the two shelving receptacles 82 positioned closest to the lower wall 76. When the second indicator 90 is activated, the plurality of lights 92 may flash, remain steadily illuminated, or illuminate in any manner consistent with the context of this disclosure.

In a similar manner, a plurality of second employee indicators 91 may be disposed at the second side 68 of the non-heated shelving unit 18 and are configured to visually indicate the shelving receptacles 82 or racks 88 of the non-heated shelving unit 18 configured to receive the food products 12 associated with the order of the first user 14. In other words, the second employee indicator 91 directs the second user 44 to the one or more shelving receptacles 82 at which the food products 12 included in the order are to be placed for later retrieval by the first user 14. The second employee indicator 91 may include a second plurality of lights 93. In the illustrated example, a portion of the second plurality of lights 93 are disposed at or adjacent to one side of each shelving receptacle 82 at the second side 68 and another portion of the second plurality of lights 93 are disposed at or adjacent to an opposing side of each shelving receptacle 82 at the second side 68. Respective portions or pairs of the second plurality of lights 93 may be illuminated at opposing sides of a shelving receptacle 82 to instruct the second user 44 to place food products 12 in the corresponding shelving receptacle 82.

The plurality of lights 92 include vertically extending light bars disposed alongside respective shelving receptacles 82 and horizontally extending light bars disposed between respective shelving receptacles 82 such that, when illuminated in groups, the plurality of lights 92 may substantially circumscribe or encircle respective first shelving openings 84 or groups of first shelving openings 84 corresponding to the respective shelving receptacles 82. In a similar manner, the second plurality of lights 93 include vertically extending light bars disposed alongside respective shelving receptacles 82. The light bars included in the plurality of lights 92 and the second plurality of lights 93 are shown as elongated or pill-shaped light bars. However, the light bars may include any suitable shape and configuration within the context of this disclosure. For example, the light bars may include a series of individualized light sources that collectively resemble a pill-shape. In another example, the light bars may be rectangularly shaped. In yet another example, the light bars may be curved or bent or otherwise un-straightened.

It should be appreciated that portions of the plurality of lights 62, 92 at both the heated storage locker 16 and the non-heated shelving unit 18, respectively, may be disposed at an angle relative to the front walls 26, 70. In other words, with the front walls 26, 70 facing in substantially the same direction as the doors 48 and first shelving openings 84, the plurality of lights 62, 92 may face in directions that are at least partially inward toward the doors 48 and first shelving openings 84. For example, and as shown in FIG. 4 and with regard to the heated storage locker 16, the portion of the plurality of lights 62 disposed adjacent to the second side wall 36 may be biased inward to partially face the plurality of first locker openings 40. In a similar manner, the portion of the plurality of lights 62 disposed adjacent to the first side wall 34 may also be angled or canted inward to partially face the plurality of first locker openings 40. Similarly, the portion of the plurality of lights 92 disposed adjacent to the second side wall 80 may be angled or canted inward to partially face the plurality of first shelving openings 84. In a similar manner, the portion of the plurality of lights 92 disposed adjacent to the first side wall 78 may also be angled or canted inward to partially face the plurality of first shelving openings 84.

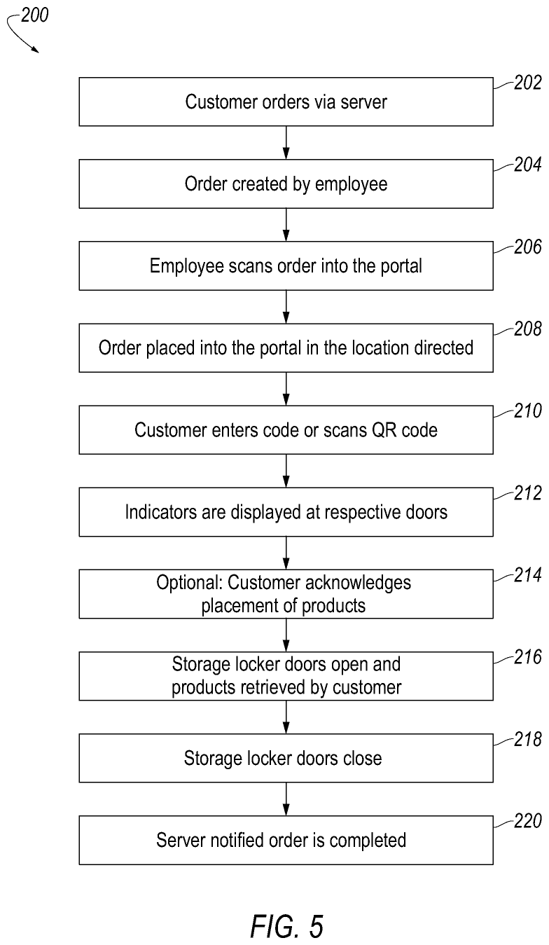

As stated above, the user interface 52 is disposed at the heated storage locker 16. However, the user interface 52 is configured to operate in conjunction with both the heated storage locker 16 and the non-heated shelving unit 18. Specifically, with reference to FIG. 5 and in a method 200 of operation of the food management system 10, at operation 202, the first user 14 places an order for the food product 12. The food product may include a first food product 12a, a second food product 12b, or both a first food product 12a and a second food product 12b. Further, the first user 14 may place the order on a mobile communication device, such as a phone, a tablet computer, or any other suitable computing device that allows the first user 14 to place an order for one or more food products 12 by communicating with the food management system 10. In this regard, the mobile communication device and the food management system 10 may communicate with and through a central processing system or server 402 (e.g., CAESARVISION®) using wired communication and/or one or more wireless communication protocols, such as WiFi, LTE, near field communication, BLUETOOTH®, or BLE® for example.

At operation 204, the order from the first user 14 is received by the second user 44 and the second user 44 prepares the order. Preparation of the order may vary based on the food products 12 included in the order. At operation 206, the second user 44 subsequently interacts with the employee interface 56. Interacting with the employee interface 56 may include the second user 44 scanning a barcode, QR code, or any scannable medium associated with the order at a scanner of the employee interface 56.

Alternatively, the second user 44 may enter a code associated with the order at a keypad or a touchscreen of the employee interface 56. For example, the scannable medium or code for inputting may be provided to the second user 44 following preparation of the food products 12. Regardless of the specific type of interaction, the employee interface 56 receives data related to the order in any suitable manner within the context of this disclosure.

After the second user 44 inputs data related to the order into the employee interface, at operation 208, the display screen 58 at the employee interface 56 provides direction regarding the specific placement of the food products 12. Additionally or alternatively, at least one of the first employee indicator 61 and the second employee indicator 91 are displayed. The first employee indicator 61 may include the second plurality of lights 63 at the heated storage locker 16 and the second employee indicator 91 may include the second plurality of lights 93 at the non-heated shelving unit 18. The first indicator 60 and the second indicator 90 correspond to the specific receptacles 38, 82 at which the food products 12 associated with the order of the first user 14 are to be deposited.

The second user 44 deposits the food products 12 at least one locker receptacle 38 of the plurality of locker receptacles 38 at the storage locker 16 and/or at least one shelving receptacle 82 of the plurality of shelving receptacles 82 at the shelving unit 18 based on at least one of the instructions provided at the employee interface 56 and the second plurality of lights 63, 93 of the first employee indicator 61 and the second employee indicator 91, respectively. For example, the display screen 58 may direct the first food product 12a to be placed in a specific locker receptacle 38 of the heated storage locker 16. Additionally, the display screen 58 may direct the second food product 12b to be placed at a specific shelving receptacle 82 of the non-heated shelving unit 18. In another example, the display screen 58 may direct the first food product 12a to be placed in two or more specific locker receptacles 38 of the heated storage locker and direct the second food product 12b to be placed in two or more specific shelving receptacles 82 of the non-heated shelving unit 18, such as if the order includes a large quantity of food products 12. The specific locker receptacles 38 and shelving receptacles 82 directed by the display screen 58 may vary based on other food products 12 associated with other orders that may already be disposed in the heated storage locker 16 and the non-heated shelving unit 18.

At operation 210, the first user 14 provides the identifier to the user interface 52 at the heated storage locker 16. The identifier is associated with the order of the first user 14. Further, the identifier may be provided to, for example, a mobile communication device of the first user 14. Providing the identifier to the mobile communication device of the first user 14 may be accomplished via communication between the mobile communication device and the food management system 10, such as through a central processing system or server 402 As described above, the user interface 52 includes the display screen 54 and may further include a touchscreen, a keypad, a scanner, or something of the like. In one example, the identifier may be a QR code or other scannable medium provided by the first user 14. The first user 14 may scan the identifier at the scanner included at the user interface 52. In another example, the identifier may be a multi-digit numerical or alphabetical code. The first user 14 may enter the code at the keypad included at the user interface 52.

Upon the user interface 52 receiving the identifier, at operation 212, at least one of the first indicator 60 and a second indicator 90 are displayed. The first indicator 60 may include the plurality of lights 62 at the heated storage locker 16 and the second indicator 90 may include the plurality of lights 92 at the non-heated shelving unit 18. The first indicator 60 and the second indicator 90 are associated with the specific receptacles 38, 82 that include the food products 12 associated with the order of the first user 14.

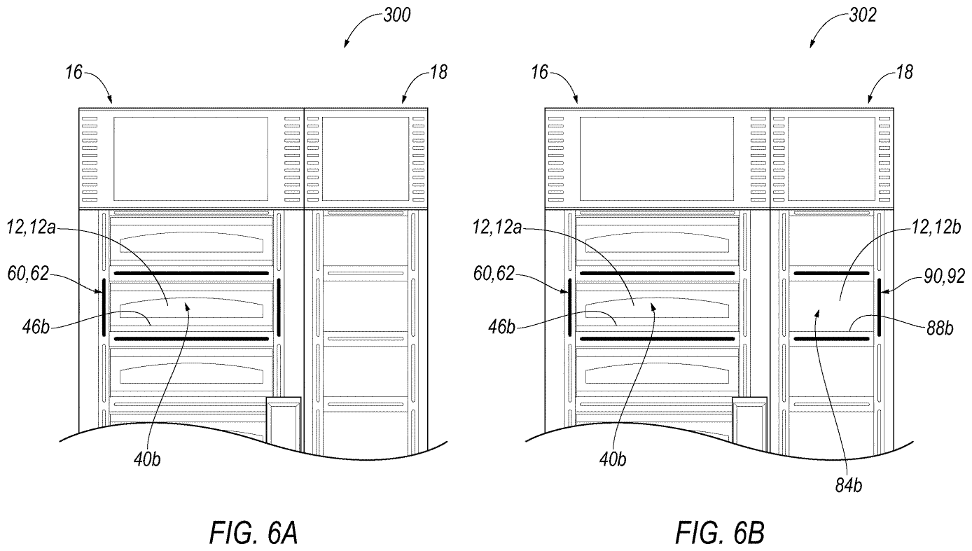

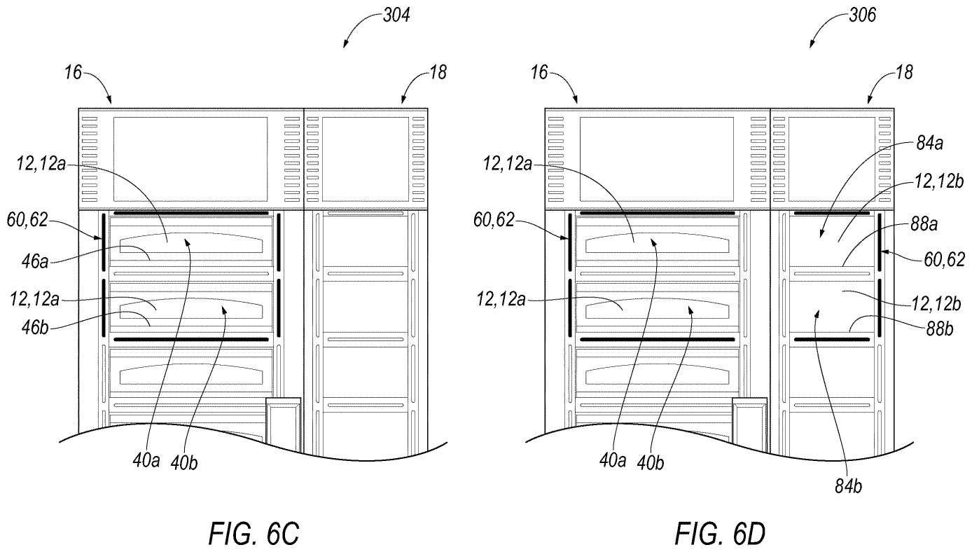

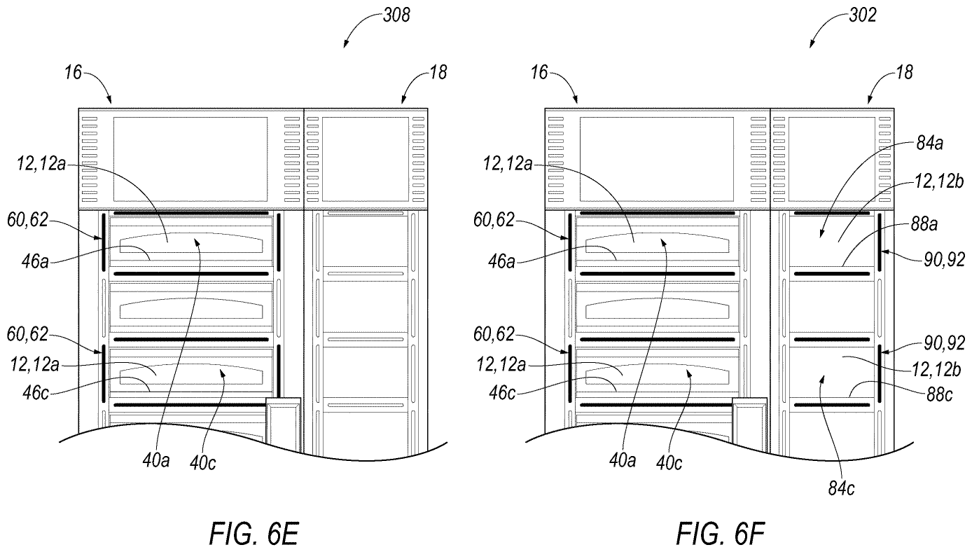

With continued reference to FIG. 5, and with reference to FIGS. 6A-6F, various portions of the plurality of lights 62 at the heated storage locker 16 and various portions of the plurality of lights 92 at the non-heated shelving unit 18 may be illuminated upon the user interface 52 receiving the identifier. The portions of the plurality of lights 62, 92 that are illuminated may vary based on the placement of the food products 12 included in the first order at the storage locker 16 and the shelving unit 18. Further, the placement of the food products 12 within the storage locker 16 and the shelving unit 18 may vary based on the real-time vacancy of the plurality of receptacles 38, 82. For example, some of the receptacles 38, 82 may be occupied by food products associated with other orders and may not be available for the food products 12 included in the order of the first user 14. The employee interface 56 is configured to direct the second user 44 to place the food products 12 in the one or more receptacles 38, 82 that can accommodate the specific food products 12 included in the order. The receptacles 38, 82 in which the second user 44 places the food products 12 are the same receptacles 38, 82 from which the first user 14 retrieves the food.

Examples of various configurations of the plurality of lights 62, 92 will now be provided. However, it should be appreciated that additional configurations of the plurality of lights 62, 92 beyond the provided examples may be included at the heated storage locker 16 and the non-heated shelving unit 18 without deviating from the context of this disclosure. Further, as stated above, the storage locker 16 is configured to accommodate the first food product 12a while the shelving unit 18 is configured to accommodate the second food product 12b.

At 300, and with reference to FIG. 6A, the first indicator 60 is displayed at the storage locker 16. Specifically, a portion of the plurality of lights 62 disposed at the storage locker 16 are illuminated to circumscribe the first locker opening 40b. This indicates to the first user 14 that the first food product 12a is located in the locker receptacle 38b corresponding to the first locker opening 40b. Further, the lack of the second indicator 90 at the shelving unit 18 indicates to the first user 14 that the shelving unit 18 does not contain any food products 12 associated with the order. The lack of the second indicator 90 also indicates to the first user 14 that the order does not include any second food product 12b.

At 302, and with reference to FIG. 6B, the first indicator 60 is displayed at the storage locker 16 and the second indicator 90 is displayed at shelving unit 18. Specifically, a portion of the plurality of lights 62 disposed at the storage locker 16 are illuminated to partially circumscribe the first locker opening 40b and a portion of the plurality of lights 92 at the shelving unit 18 are illuminated to partially circumscribe the first shelving opening 84b. The portions of the plurality of lights 62, 92 that are illuminated entirely, conjunctively, and collectively circumscribe the first locker opening 40b and the first shelving opening 84b. This is accommodated by the first locker opening 40b and the first shelving opening 84b being adjacent to one another. This indicates to the first user 14 that the first food product 12a is located in the locker receptacle 38b corresponding to the first locker opening 40b and the second food product 12b is located in the receptacle 88b corresponding to the first shelving opening 84b.

At 304, and with reference to FIG. 6C, the first indicator 60 is displayed at the storage locker 16. Specifically, a portion of the plurality of lights 62 disposed at the storage locker 16 are illuminated to partially circumscribe the first locker opening 40a and partially circumscribe the first locker opening 40b. The portions of the plurality of lights 62 that are illuminated entirely, conjunctively, and collectively circumscribe the first locker opening 40a and the first locker opening 40b. This is accommodated by the first locker openings 40a, 40b being adjacent to one another. This indicates to the first user 14 that the first food product 12a is located in the locker receptacle 38a corresponding to the first locker opening 40a and that another first food product 12a is located in the locker receptacle 38b corresponding to the first locker opening 40b. Further, the lack of the second indicator 90 at the shelving unit 18 indicates to the first user 14 that the shelving unit 18 does not contain any food products 12 associated with the order. The lack of the second indicator 90 also indicates to the first user 14 that the order does not include the second food product 12b.

At 306, and with reference to FIG. 6D, the first indicator 60 is displayed at the storage locker 16 and the second indicator 90 is displayed at shelving unit 18. Specifically, a portion of the plurality of lights 62 disposed at the storage locker 16 are illuminated to partially circumscribe the first locker openings 40a, 40b and a portion of the plurality of lights 92 at the shelving unit 18 are illuminated to partially circumscribe the first shelving openings 84a, 84b. The portions of the plurality of lights 62, 92 that are illuminated entirely, conjunctively, and collectively circumscribe the first locker openings 40a, 40b and the first shelving openings 84a, 84b. This is accommodated by the first locker opening 40a and the first shelving opening 84a being adjacent to one another, the first locker opening 40b and the first shelving opening 84b being adjacent to one another, the first locker openings 40a, 40b being adjacent to one another, and the first shelving openings 84a, 84b being adjacent to one another. This indicates to the first user 14 that the first food products 12a are located in the locker receptacles 38a, 38b corresponding to the first locker openings 40a, 40b, respectively, and the second food products 12b are located in the shelving receptacles 82a, 82b corresponding to the first shelving openings 84a, 84b, respectively.

At 308, and with reference to FIG. 6E, the first indicator 60 is displayed at the storage locker 16. Specifically, a portion of the plurality of lights 62 disposed at the storage locker 16 are illuminated to circumscribe the first locker opening 40a, and another portion of the plurality of lights 62 disposed at the storage locker 16 are illuminated to circumscribe the first locker opening 40c. This indicates to the first user 14 that the first food product 12a is located in the locker receptacle 38a corresponding to the first locker opening 40a, and that another first food product 12a is located in the receptacle 46c corresponding to the first locker opening 40c. Further, the lack of the second indicator 90 at the shelving unit 18 indicates to the first user 14 that the shelving unit 18 does not contain any food products 12 associated with the order. The lack of the second indicator 90 also indicates to the first user 14 that the order does not include the second food product 12b.

At 310, and with reference to FIG. 6F, the first indicator 60 is displayed at the storage locker 16 and the second indicator 90 is displayed at shelving unit 18. Specifically, a portion of the plurality of lights 62 disposed at the storage locker 16 are illuminated to partially circumscribe the first locker opening 40a and a portion of the plurality of lights 92 at the shelving unit 18 are illuminated to partially circumscribe the first shelving opening 84a. Additionally, another portion of the plurality of lights 62 disposed at the storage locker 16 are illuminated to partially circumscribe the first locker opening 40c and another portion of the plurality of lights 92 at the shelving unit 18 are illuminated to partially circumscribe the first shelving opening 84c. The portions of the plurality of lights 62, 92 that are illuminated entirely, conjunctively, and collectively circumscribe the first locker opening 40a and the first shelving opening 84a. This is accommodated by the first locker opening 40a and the first shelving opening 84a being adjacent to one another. Additionally, the other portions of the plurality of lights 62, 92 that are illuminated entirely, conjunctively, and collectively circumscribe the first locker opening 40c and the first shelving opening 84c. This is accommodated by the first locker opening 40c and the first shelving opening 84c being adjacent to one another. This indicates to the first user 14 that the first food product 12a is located in the locker receptacles 38a, 38c corresponding to the first locker openings 40a, 40c, respectively, and the second food product 12b is located in the shelving receptacles 82a, 82c corresponding to the first shelving openings 84a, 84c, respectively.

In some examples, the display screen 54 at the user interface 52 may display a message that indicates the specific receptacles 38, 82 that include the food products 12 associated with the order of the first user 14. At operation 214, in some optional implementations, the display screen 54 may also prompt the first user 14 to acknowledge the one or more receptacles 38, 82 that include the food products 12. For example, the user interface 52 may require the first user 14 to press the touch-screen or the keypad included at the display screen 54 to acknowledge the first food product 12a is located within a specific locker receptacle 38 in the storage locker 16 and the second food product 12b is located within a specific shelving receptacle 82 in the shelving unit 18.

Further, the first user 14 may have to make a series of acknowledgements at the user interface 52 based on the quantity of receptacles 38, 82 holding the food products 12. For example, the first user 14 may have to acknowledge the placement of the first food product 12a in the one or more locker receptacles 38 in the storage locker 16 before acknowledging the placement of the second food product 12b in the one or more shelving receptacles 82 in the shelving unit 18. Optionally, the message displayed at the display screen 54 may not specify the specific receptacles 38, 82, and instead remind the first user 14 to ensure that all the food products 12 are picked up, such as via a reminder to view the illuminated indicators 60, 90 and/or to check the shelving unit 18 for forgotten items. The display screen 54 may display the prompt (or not display the prompt) based on a classification of the first user 14. By way of example, the prompt may not be displayed to users who are directly associated with the order (e.g., placed the order themselves) while the prompt may be displayed to third party users (e.g., delivery drivers) who are picking up the order on behalf of the first user 14.

After the first user 14 acknowledges the placement of the food products 12, at operation 216, the first food product 12a and/or the second food product 12b are retrieved by the first user 14. In some configurations, the first user 14 may have to acknowledge the placement of the first food product 12a in the storage locker 16 and retrieve the first food product 12a before acknowledging the placement of the second food product 12b in the shelving unit 18 and subsequently retrieving the second food product 12b. Further, in examples wherein the storage locker 16 includes the plurality of first doors 48, the first door 48 corresponding to the locker receptacle 38 holding the first food product 12a may open upon acknowledgement of the first food product 12a at the display screen. The first door 48 may be opened automatically or manually. In examples wherein the shelving unit 18 includes the covering, the covering may have to be moved, pushed aside, or otherwise manipulated prior to retrieving the second food product 12b.

At operation 218, after the food products 12 have been retrieved by the first user 14, the first doors 48 associated with the order close. The first doors 48 may be closed automatically or manually. Finally, at operation 220, the central processing system or server 402 is notified that the order is complete. Notification to the server may occur via wired communication and/or one or more wireless communication protocols, such as WiFi, LTE, near field communication, BLUETOOTH®, or BLER for example.

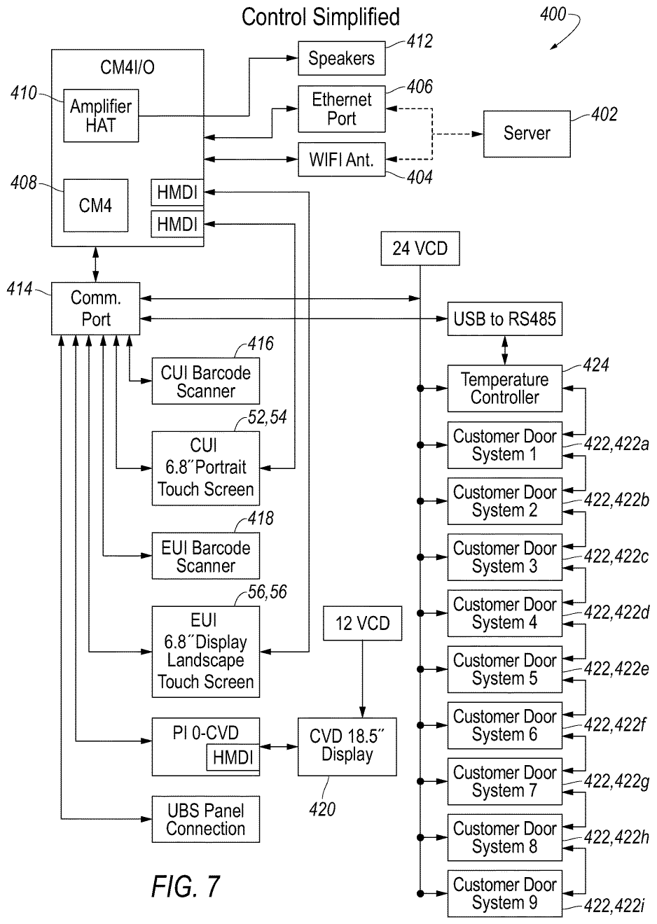

With reference to FIG. 7, a control system 400 of the food management system 10 is provided. It should be appreciated that the specific configuration of the control system 400 may vary without deviating from the context of this disclosure.

As stated above, the central processing system or server 402 enables communication between, for example, the mobile communication device and the food management system 10. Wireless communication may be enabled by a WiFi antenna 404 and wired communication may be enabled by an ethernet port 406. Communication may be sent and received at a control module 408 of the food management system 10. The food management system 10 may also include an amplifier 410 that is in communication with a speaker 412. The speaker 412 may be disposed at the heated storage locker 16 or the non-heated shelving unit 18 and configured to provide audio. For example, the speaker 412 may be configured to emit a chime or a sound or something of the like that indicates to the first user 14 that the order has successfully been retrieved.

An electrical communication port 414, such as a USB hub, an RS485 connector, or something of the like, may be connected to the control module 408 of the food management system 10. The electrical communication port 414 provides an interface to connect the control module 408 to other components included at the heated storage locker 16 and the non-heated shelving unit 18. For example, the display screen 54 at the user interface 52, as well as the display screen 58 at the employee interface 56, may be connected to the electrical communication port 414. Further, a barcode scanner 416 disposed at the user interface 52, as well as a barcode scanner 418 at the employee interface 56, may also be connected to the electrical communication port 414. The barcode scanners 416, 418 enable the user interface 52 and the employee interface 56, respectively, to read QR codes or other scannable mediums. A billboard display 420 may also be disposed at the heated storage locker 16, the non-heated shelving unit 18, or both the heated storage locker 16 and the non-heated shelving unit 18. The billboard display 420 provides accommodations to display a configurable digital image. For example, the billboard display 420 may display a business logo or marketing image or something of the like.

The electrical communication port 414 may also connect a plurality of first door systems 422 to the control module 408. Each first door system 422 of the plurality of first door systems 422 corresponds to each first door 48 of the plurality of first doors 48. In this regard, the nine first doors 48a-48i correspond to nine first door systems 422a-422i included at the storage locker 16. The first door systems 422 may operate the plurality of first doors 48 between the open position and the closed position. Further, a temperature controller 424 of a heating system of the heated storage locker 16 may be connected to the electrical communication port 414 that is configured to control a temperature within the plurality of locker receptacles 38 at the storage locker 16.

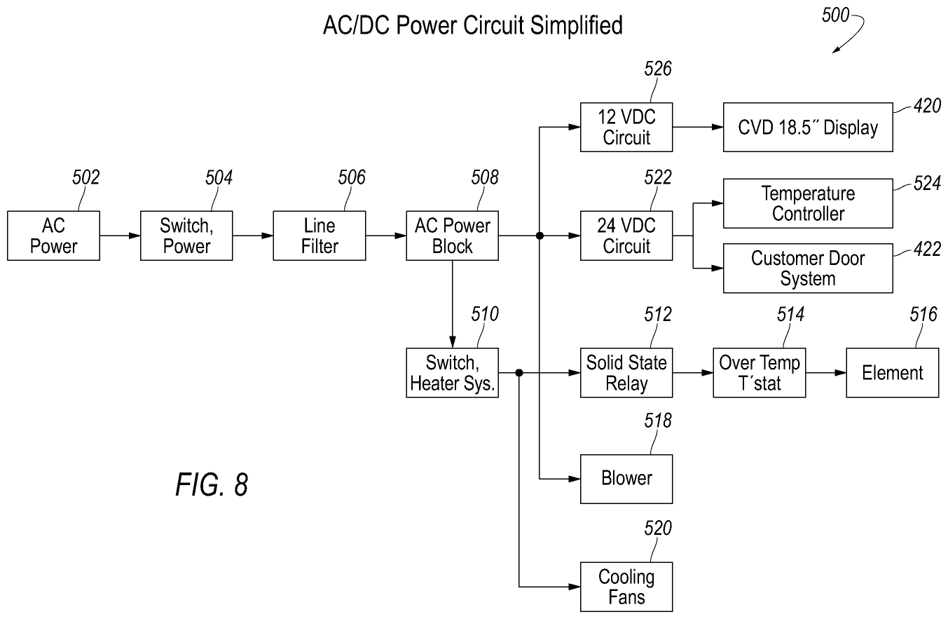

With reference to FIG. 8, a power circuit system 500 of the food management system 10 is provided. The power circuit system 500 is configured to provide electrical power for the food management system 10. It should be appreciated that the specific configuration of the power circuit system 500 may vary without deviating from the context of this disclosure.

Operation of the food management system 10 is accommodated by AC power 502 that is sent to a switch 504 included at the heated storage locker 16 or the non-heated shelving unit 18. The switch 504 may be configurable to enable and disable electrical flow of the AC power 502. The AC power 502 then travels through a line filter 506 and is routed to an AC power block 508 that is configured to direct the AC power 502 to various components included at the food management system 10. For example, AC power 502 may be sent to a heater system switch 510. The heater system switch 510 may be configured to enable and disable electrical flow of the AC power 502 to components at the heated storage locker 16 configured to regulate temperature within the plurality of locker receptacles 38. For example, the AC power 502 may be directed to a solid-state relay 512, a thermostat 514, and a heating element 516. The solid-state relay 512, the thermostat 514, and the heating element 516 may operate in tandem with one another to maintain a desired temperature within the plurality of locker receptacles 38. Further, the AC power 502 may be directed to a blower 518 and cooling fans 520 that are also configured to maintain a desired temperature within the plurality of locker receptacles 38.

The AC power block 508 may also route the AC power 502 to a 24-volt DC circuit 522 included at the heated storage locker 16. The 24-volt DC circuit 522 may enable operation of the plurality of first door systems 422. Further, the 24-volt DC circuit 522 may also operate a temperature controller 524. The temperature controller 524 may enable user-configurable adjustment of a temperature within the plurality of locker receptacles 38. The AC power block 508 may also route the AC power 502 to a 12-volt DC circuit 526 included at the heated storage locker 16. The 12-volt DC circuit 526 may enable operation of the billboard display 420 at the heated storage locker 16.

Optionally, the food management system and food locker may utilize characteristics of the food management systems and lockers described in U.S. Pub. No. US-2022-0383250, which is hereby incorporated herein by reference in its entirety.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed on data processing hardware causes the data processing hardware to perform operations comprising:
receiving an order associated with a first user and including a first product and a second product;
instructing a second user to deposit the first product in at least one receptacle of a plurality of receptacles of a heated storage device and to deposit the second product in at least one receptacle of a plurality of receptacles of a non-heated storage device;
receiving, at the heated storage device, an identifier associated with the order and the first user; and
responsive to receiving the identifier, activating a first indicator that indicates the at least one receptacle of the heated storage device and activating a second indicator that indicates the at least one receptacle of the non-heated storage device.

2. The computer-implemented method of claim 1, wherein the heated storage device includes a user interface, and wherein the identifier is received at the user interface.

3. The computer-implemented method of claim 2, wherein the user interface includes a display screen.

4. The computer-implemented method of claim 3, wherein the operations further comprise displaying a message at the display screen that indicates at least one selected from the group consisting of (i) the at least one receptacle of the heated storage device and (ii) the at least one receptacle of the non-heated storage device.

5. The computer-implemented method of claim 1, wherein the heated storage device includes an employee interface having a display screen, and wherein instructing the second user comprises displaying a message at the display screen.

6. The computer-implemented method of claim 5, wherein the order is received at the employee interface.

7. The computer-implemented method of claim 1, wherein instructing the second user to deposit the first product comprises instructing the second user to deposit the first product in two or more receptacles of the plurality of receptacles of the heated storage device, and wherein the first indicator indicates the two or more receptacles of the heated storage device.

8. The computer-implemented method of claim 1, wherein instructing the second user to deposit the second product comprises instructing the second user to deposit the second product in two or more receptacles of the plurality of receptacles of the non-heated storage device, and wherein the second indicator indicates the two or more receptacles of the non-heated storage device.

9. The computer-implemented method of claim 1, wherein the first indicator includes a plurality of lights that at least partially circumscribe at least one first opening corresponding to the at least one receptacle of the heated storage device, and wherein the second indicator includes a plurality of lights that at least partially circumscribe at least one first shelving opening corresponding to the at least one receptacle of the non-heated storage device.

10. The computer-implemented method of claim 9, wherein the at least one receptacle of the heated storage device and the at least one receptacle of the non-heated storage device are adjacent to one another, and wherein a portion of the plurality of lights of the first indicator and a portion of the plurality of lights of the second indicator are activated so that the activated portions collectively circumscribe the at least one first opening corresponding to the at least one receptacle of the heated storage device and the at least one first opening corresponding to the at least one receptacle of the non-heated storage device.

11. The computer-implemented method of claim 1, wherein the heated storage device comprises a heated storage locker.

12. The computer-implemented method of claim 1, wherein the non-heated storage device comprises a non-heated shelving unit.

13. The computer-implemented method of claim 1, wherein the identifier comprises one of (i) a QR code or other scannable medium received at a scanner of the heated storage device and (ii) a numerical pin or other input received at the heated storage device.

14. A food management system comprising:
a heated storage locker including:
a first side including a plurality of first locker openings;
a second side opposite the first side, the second side including a plurality of second locker openings; and
a plurality of locker receptacles, each locker receptacle of the plurality of locker receptacles extending between a respective first locker opening of the plurality of first locker openings and a respective second locker opening of the plurality of second locker openings;
a non-heated shelving unit including:
a first side including a plurality of first shelving openings;
a second side opposite the first side, the second side including a plurality of second shelving openings; and
a plurality of shelving receptacles, each shelving receptacle of the plurality of shelving receptacles extending between a respective first shelving opening of the plurality of first shelving openings and a respective second shelving opening of the plurality of second shelving openings; and
an employee interface disposed at the second side of the heated storage locker, the employee interface configured to, responsive to receiving an order associated with a first user and including a first food product and a second food product, instruct a second user to deposit the first food product in at least one locker receptacle of the plurality of locker receptacles and to deposit the second food product in at least one shelving receptacle of the plurality of shelving receptacles; and
a user interface disposed at the first side of the heated storage locker, the user interface configured to receive an identifier associated with the order associated with the first user and activate a first indicator that indicates the at least one locker receptacle of the heated storage locker and a second indicator that indicates the at least one shelving receptacle of the non-heated shelving unit.

15. The food management system of claim 14, wherein the employee interface includes a display screen configured to display a message to instruct the second user.

16. The food management system of claim 15, wherein the message at the display screen of the employee interface indicates (i) the at least one locker receptacle of the plurality of locker receptacles of the heated storage locker and (ii) the at least one shelving receptacle of the plurality of shelving receptacles of non-heated shelving unit.

17. The food management system of claim 14, wherein the user interface includes a display screen configured to display a message that indicates at least one selected from the group consisting of (i) the at least one locker receptacle of the plurality of locker receptacles of the heated storage locker and (ii) the at least one shelving receptacle of the plurality of shelving receptacles of non-heated shelving unit.

18. The food management system of claim 14, wherein the first indicator includes a plurality of lights that at least partially circumscribe at least one first locker opening of the plurality of first locker openings corresponding to the at least one locker receptacle of the heated storage locker, and wherein the second indicator includes a plurality of lights that at least partially circumscribe at least one first shelving opening of the plurality of first shelving openings corresponding to the at least one shelving receptacle of the non-heated shelving unit.

19. The food management system of claim 18, wherein the at least one locker receptacle of the heated storage locker and the at least one shelving receptacle of the non-heated shelving unit are adjacent one another, and wherein a portion of the plurality of lights of the first indicator and a portion of the plurality of lights of the second indicator are activated so that the activated portions of the plurality of lights collectively circumscribe the at least one first locker opening corresponding to the at least one locker receptacle of the heated storage locker and the at least one first shelving opening corresponding to the at least one shelving receptacle of the non-heated shelving unit.

20. The food management system of claim 14, wherein the identifier comprises one of (i) a QR code or other scannable medium received at a scanner of the user interface of the heated storage locker and (ii) a numerical pin or other input received at the user interface of the heated storage locker.
